(19) United States
(12) Patent Application Publication
(10) Pub. No.: US 2007/0268539 A1
(43) Pub. Date: Nov. 22, 2007

(54) APPARATUS AND METHOD FOR HOLOGRAPHIC RECORDING AND REPRODUCING

(75) Inventors: Mitsuru Toishi, Kanagawa (JP); Masaaki Hara, Tokyo (JP); Kenji Tanaka, Tokyo (JP); Koji Ishioka, Kanagawa (JP); Atsushi Fukumoto, Kanagawa (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 11/745,931

(22) Filed: May 8, 2007

(30) Foreign Application Priority Data
May 16, 2006 (JP) P2006-136229
Sep. 8, 2006 (JP) P2006-244126

(51) Int. Cl. G03H 1/12

(52) U.S. Cl. 359/11

(57) ABSTRACT

A holographic recording and reproducing apparatus is provided. The holographic recording and reproducing apparatus includes a signal-beam spatial light modulating unit that displays a signal beam pattern for a signal beam, a reference-beam spatial light modulating unit that displays a reference beam pattern for a reference beam, and a controller that controls the mode of the signal beam pattern and that of the reference beam pattern. The controller controls the modes of at least two signal beam patterns and the modes of at least two reference beam patterns. A first reference beam is made to interfere with a first signal beam based on first recording data to record the data as a first hologram in a predetermined area of the holographic recording medium. A second reference beam is made to interfere with a second signal beam based on second recording data to record the data as a second hologram such that the second hologram is superimposed on the first hologram.

### CROSS REFERENCES TO RELATED APPLICATIONS

The present application claims priority to Japanese Patent Application JP 2006-136229 filed in the Japanese Patent Office on May 16, 2006, and Japanese Patent Application JP 2006-244126 filed in the Japanese Patent Office on Sep. 8, 2006, the entire contents of which are are incorporated herein by reference.

### BACKGROUND

The present disclosure relates to an apparatus and method for holographic recording and reproducing.

Recently, attention has been given to holographic memories, serving as recording and reproducing apparatuses capable of achieving high recording density, recording data at high transfer rate, and reproducing recorded data at high rate. A holographic memory utilizes the direction along the thickness of a recording medium in order to record data. During recording, interference fringes produced by a predetermined reference beam and a signal beam based on data to be recorded as two-dimensional information page by page are formed as a hologram in a holographic recording medium, so that the information is three-dimensionally recorded at once. During reproducing, the reference beam is applied to the hologram formed as described above to obtain a diffracted beam, thus reproducing the data recorded page by page, as disclosed in Japanese Unexamined Patent Application Publication No. 2004-226821 and the magazine, “NIKKEI ELECTRONICS”, Jan. 17, 2005, pp. 106-114.

When recorded data is reproduced from a hologram recorded by a holographic recording and reproducing apparatus, shift selectivity is very narrow. While a holographic recording area is slightly shifted using the narrow shift selectivity, holograms are recorded so as to overlap each another. Such a recording method is called shift multiplexing. In some cases, the shift multiplexing recording method is used to increase the amount of data recorded on a holographic recording medium, as described in “NIKKEI ELECTRONICS”, Jan. 17, 2005, pp. 106-114.

In the use of shift multiplexing recording described above, the amount of data recorded on a holographic recording medium is orders of magnitude higher than those of conventional recording media. It is desired that the amount of data recordable on a holographic recording medium be further increased.

It is desirable to provide an apparatus and method for holographic recording and reproducing, the apparatus and method capable of increasing the amount of data recorded on a holographic recording medium.

### SUMMARY

According to an embodiment, there is provided a holographic recording and reproducing apparatus for making a signal beam, which is emitted from a light source and is modulated based on recording data for each page, interfere with a reference beam emitted from the same light source as that emitting the signal beam to form a hologram in a recording layer of a holographic recording medium and for reproducing the recording data for each page on the basis of a diffracted beam obtained by irradiation of the holographic recording medium with the reference beam. The apparatus includes the following elements. A signal-beam spatial light modulating unit displays a signal beam pattern for generating the signal beam. A reference-beam spatial light modulating unit displays a reference beam pattern for generating the reference beam. A controller controls the mode of the signal beam pattern displayed in the signal-beam spatial light modulating unit and that of the reference beam pattern displayed in the reference-beam spatial light modulating unit. In this apparatus, the controller controls the modes of at least two signal beam patterns and the modes of at least two reference beam patterns. The controller allows for recording of at least two recording data units in such a manner that a first reference beam generated using a predetermined first reference beam pattern is made interfere with a first signal beam generated using a first signal beam pattern based on first recording data to record the first recording data in the form of a first hologram in a predetermined area of the holographic recording medium and a second reference beam generated using a predetermined second reference beam pattern is made interfere with a second signal beam generated using a second signal beam pattern based on second recording data to record the second recording data in the form of a second hologram such that the second hologram is superimposed on the first hologram. The controller allows for reproducing of at least the two recording data units in such a manner that the first recording data is reproduced on the basis of a diffracted beam obtained by irradiation of the first hologram with the first reference beam and the second recording data is reproduced on the basis of a diffracted beam obtained by irradiation of the second hologram with the second reference beam.

According to another embodiment, there is provided a method for holographic recording and reproducing such that a hologram is recorded in a recording layer of a holographic recording medium by allowing a signal beam, which is emitted from a light source and is modulated based on recording data for each page, to interfere with a reference beam emitted from the same light source as that emitting the signal beam and the recording data for each page is reproduced on the basis of a diffracted beam obtained by irradiation of the holographic recording medium with the reference beam. The method includes making a first reference beam interfere with a first signal beam based on first recording data to record the first recording data in the form of a first hologram in a predetermined area in the holographic recording medium, making a second reference beam interfere with a second signal beam based on second recording data to record the second recording data in the form of a second hologram such that the second hologram is superimposed on the first hologram, reproducing the first recording data on the basis of a diffracted beam obtained by irradiation of the first hologram with the first reference beam, and reproducing the second recording data on the basis of a diffracted beam obtained by irradiation of the second hologram with the second reference beam.

In the apparatus and method for holographic recording and reproducing according to the embodiments, during recording, the first reference beam is made interfere with the first signal beam based on the first recording data to form the first hologram in the predetermined area of the holographic recording medium. The second signal beam is made to interfere with the second signal beam based on the second recording data to form the second hologram such that the second hologram is superimposed on the first hologram. Consequently, the first and second holograms are recorded in one area or areas overlapping each other in the holographic recording medium. During reproducing, the first recording data is reproduced using a diffracted beam obtained by irradiation of the first hologram with the first reference beam and the second recording data is reproduced using a diffracted beam obtained by irradiation of the second hologram with the second reference beam.

According to the embodiments, the apparatus and method for holographic recording and reproducing can increase the amount of data recorded on a holographic recording medium.

Additional features and advantages are described herein, and will be apparent from, the following Detailed Description and the figures.

### BRIEF DESCRIPTION OF THE FIGURES

FIG. 1 is a conceptual diagram of a coaxial optical system in a holographic recording apparatus;

FIG. 2 shows an example of a signal beam pattern and a reference beam pattern displayed in a spatial light modulator;

FIG. 3 is a conceptual diagram of a coaxial optical system in a holographic reproducing apparatus;

FIG. 4 is a schematic diagram of a holographic recording and reproducing apparatus according to an embodiment, FIG. 4 showing optical components, serving as major part of the apparatus;

FIG. 5 is a schematic diagram of the structure (cross section) of a holographic recording medium;

FIGS. 6A to 6D show results of recording and reproducing by a recording and reproducing method according to an embodiment as reproduced images captured by an image sensor;

FIGS. 7A to 7C show results of recording and reproducing by encryption according to an embodiment as reproduced images captured by the image sensor;

FIG. 8 shows examples of two reference beam patterns displayed in the spatial light modulator;

FIG. 9 shows the autocorrelation function of diffraction fringes formed by a reference beam based on a reference beam pattern and a signal beam, the autocorrelation function being obtained by numerical analysis;

FIG. 10 shows the cross-correlation function of diffraction fringes formed by reference beams based on different reference beam patterns and a signal beam, the cross-correlation function being obtained by numerical analysis;

FIG. 11 shows the characteristics obtained when the recording and reproducing operations are performed using two different reference beam patterns;

FIG. 12A shows an image captured by the image sensor when a hologram is formed using a reference beam pattern 1 and the image is reproduced by irradiation of the hologram with the reference beam pattern 1;

FIG. 12B shows an image captured by the image sensor when the image is reproduced by irradiation of the hologram with a reference beam pattern 2;

FIG. 13A shows an image captured by the image sensor when the image is reproduced by irradiation of a hologram using a reference beam pattern, the hologram being one of holograms recorded by shift multiplexing using the same reference beam pattern;

FIG. 13B shows an image captured by the image sensor when the image is reproduced by irradiation of a hologram using a reference beam pattern, the hologram being one of holograms recorded by shift multiplexing using different reference beam patterns; and

FIG. 14 shows examples of three reference beam patterns displayed in the spatial light modulator.

### DETAILED DESCRIPTION

First, a coaxial holographic recording and reproducing apparatus having a coaxial optical system is described as an example of a holographic recording and reproducing apparatus. Subsequently, the theory of operation of an apparatus for holographic recording and reproducing according to an embodiment and a method for holographic recording and reproducing according to an embodiment is sequentially described.

Terms Used in This Specification

Terms used in the present specification will be explained. In the following description, a term “uncorrelation” will be used as a word meaning the conceptual relationship between a reference beam pattern (e.g., a first reference beam pattern) and another reference beam pattern (e.g., a second reference beam pattern). Uncorrelation means that both of a pixel in a reference beam pattern displayed in a reference-beam spatial light modulating unit 47 of a spatial light modulator 22 and the same pixel (i.e., the pixel in the same position) in another reference beam pattern displayed in the reference-beam spatial light modulating unit 47 are not white. In the following description, a pixel that allows a light beam to pass therethrough in the spatial light modulator 22 is called a white pixel. In addition, a pixel that reflects a beam in a spatial light modulator 37 is also termed a white pixel. The spatial light modulators 22 and 37 are described later. Pixels are also described later. In the use of three or more reference beam patterns, uncorrelation means that when a pixel in a first reference beam pattern is white, the same pixel in each of other reference beam patterns is not white. The term “uncorrelation” will be used with respect to not only the relationship between reference beam patterns but also that between reference beams generated by the above-described reference beam patterns.

A term “white rate” is used in the following description. A white rate means a proportion of white pixels in relation to the total number of pixels in each of the spatial light modulator 37 and the spatial light modulator 22 when a reference beam pattern, formed in each of the spatial light modulators 37 and 22, includes two kinds of pixels corresponding to binary information, i.e., white pixels and black pixels. In the spatial light modulator 37, a pixel that absorbs a light beam without reflecting the beam will be called a black pixel. In the spatial light modulator 22, a pixel that blocks transmission of a light beam is called a black pixel. In an embodiment, pixels in the spatial light modulator 37 or 22, serving as a single spatial light modulator, are controlled to display a reference beam pattern in a multi-mode. Accordingly, the white rate is determined for each reference beam pattern.

A term “M/# (M number)” is used in the following description. M/# represents an index of overwriting in a holographic recording medium. The higher the value of M/#, the larger the number of overwriting times in the same area in a recording layer. A term “low consumption of M/#” means that overwriting with the effect of increasing storage density has been effectively performed. A term “high consumption of M/#” means the opposite of the meaning of the above term, i.e., means that overwriting with this effect has not been effectively performed.

A term “pixel” is used with respect to the spatial light modulator 37 and an image sensor 25. A pixel is a minimum unit in which a controller 60 can control the mode of a signal beam pattern or a reference beam pattern in the spatial light modulator. In addition, a pixel also corresponds to a minimum unit in which a reproduced image can be captured into the controller through the image sensor 25. It is desirable that one pixel in the spatial light modulator 37 optically correspond to one pixel in the image sensor 25 in terms of simplicity in control and processing by the controller 60. However, it is unnecessary that one pixel in the spatial light modulator 37 should optically correspond to that in the image sensor 25.

A term “one symbol” will be used. One symbol is a unit including a two-dimensional array of pixels. For example, pixels arranged in 4 columns and 4 rows, i.e., 4×4 pixels constitute one symbol. One symbol corresponds to digital data having a predetermined bit length, that is, one symbol is encoded as a block code in an embodiment. The term “one symbol” will also be used as a unit including a two-dimensional array of pixels in an image sensor. Although other several terms will be used in the following description, each term which is not so general to those skilled in the art will be explained in brief as occasion demands.

Coaxial Holographic Recording and Reproducing Apparatus

A coaxial holographic recording and reproducing apparatus can record and reproduce data using a single objective lens because a signal beam and a reference beam, which is described below, are allowed to share part of the optical path of a light beam. Accordingly, an optical system can be simplified. Further, since the coaxial holographic recording and reproducing apparatus has compatibility, that is, known optical disks, such as CDs and DVDs, can be relatively easily used, attention is given to the apparatus, serving as a further recording and reproducing apparatus.

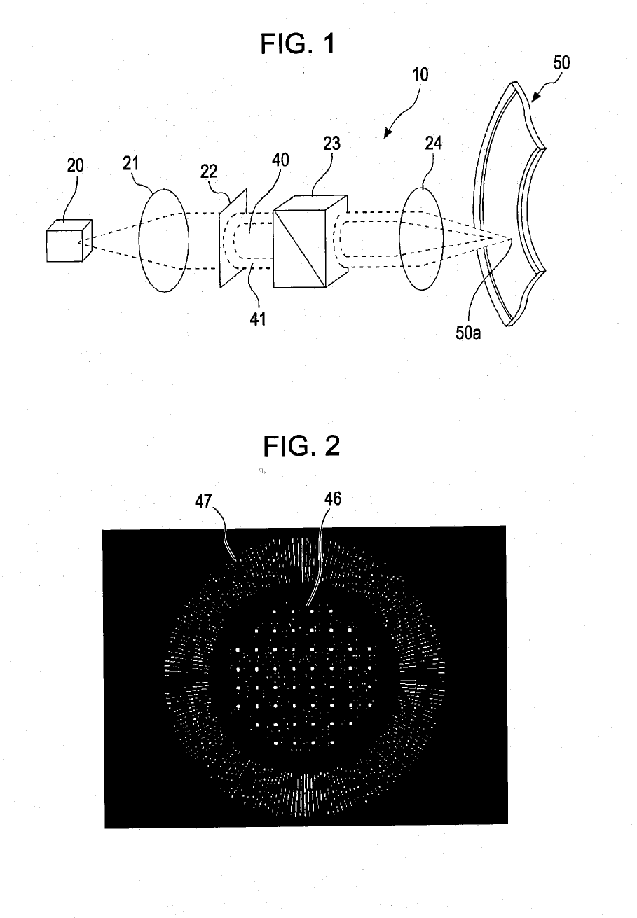

FIG. 1 is a conceptual diagram of a coaxial optical system 10 in a coaxial holographic recording apparatus. The coaxial optical system 10 includes a laser source 20, a collimating lens 21, the spatial light modulator 22 including transmissive liquid crystal, a beam splitter 23, and an objective lens 24 as major optical components.

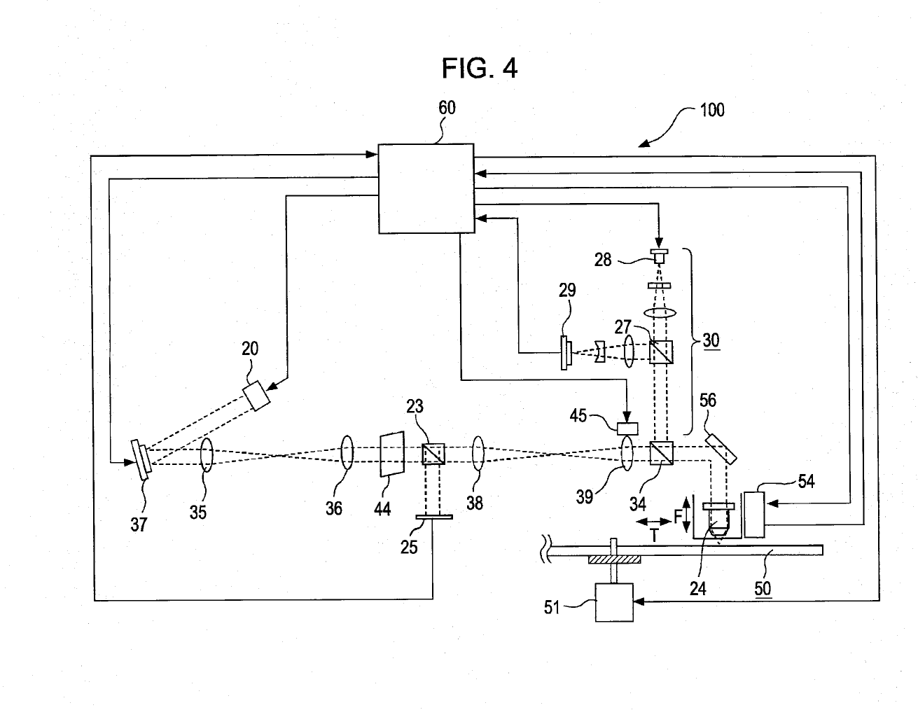

A light beam emitted from the laser source 20 is collimated by the collimating lens 21. The collimated beam passes through the spatial light modulator 22. The spatial light modulator 22 includes two beam transmission areas, serving as a signal-beam spatial light modulating unit 46 (refer to FIG. 2) for displaying a signal beam pattern based on data to be recorded (hereinafter, recording data) and the reference-beam spatial light modulating unit 47 (see FIG. 2) for displaying a reference beam pattern. The light beam passing through the two areas of the spatial light modulator 22 provides a signal beam 40 and a reference beam 41 which are coaxially arranged so as to have the same axis. The signal beam 40 and the reference beam 41 pass through the common optical components, i.e., the beam splitter 23 and the objective lens 24. In other words, the signal beam 40 and the reference beam 41 are incident on a recording layer 50a (refer to FIG. 4) of a holographic recording medium 50 through the same optical path. The signal beam 40 generated by the signal-beam spatial light modulating unit 46 interferes with the reference beam 41 generated by the reference-beam spatial light modulating unit 47 in the recording layer 50a. The refractive index of light in a micro area in the recording layer 50a changes in accordance with the state of interference, so that recording data is recorded as a diffraction grating (hologram) corresponding to a refractive index pattern.

FIG. 2 shows an example of a signal beam pattern and a reference beam pattern displayed in the spatial light modulator 22. In this example, the signal beam pattern is displayed by the signal-beam spatial light modulating unit 46 located close to the center of the spatial light modulator 22 and the reference beam pattern is displayed in the reference-beam spatial light modulating unit 47 surrounding the signal-beam spatial light modulating unit 46. Referring to FIG. 2, black part includes black pixels which block a light beam and white part includes white pixels which allow a light beam to pass therethrough. A signal beam and a reference beam vary in accordance with the arrangement of black pixels and white pixels.

The reference beam pattern is previously determined and is not limited to the example, shown in FIG. 2, having a spoke pattern in which radially extending lines are formed by white pixels and white and black portions are alternately arranged. A random pattern, in which white and black pixels are arranged at random, formed by previously generating a random number may be used.

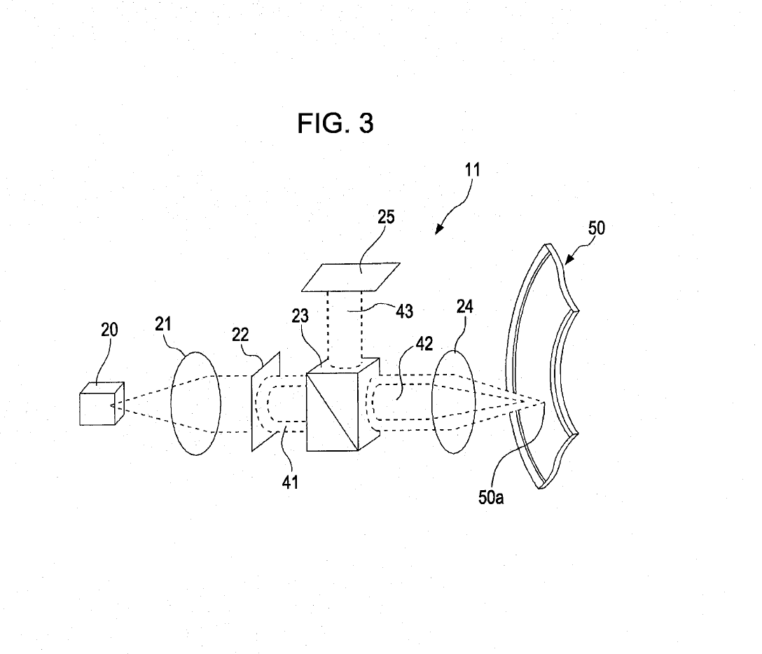

FIG. 3 is a conceptual diagram of a coaxial optical system 11 used in a coaxial holographic reproducing apparatus. The coaxial holographic reproducing apparatus includes the image sensor 25 including a charge coupled device (CCD) in addition to the above-described laser source 20, the collimating lens 21, the spatial light modulator 22, the beam splitter 23, and the objective lens 24.

During reproducing, a reference beam pattern alone is displayed on the reference-beam spatial light modulating unit 47 of the spatial light modulator 22 and the signal-beam spatial light modulating unit 46 displays a whole black pattern including only black pixels that obstruct transmission of a light beam. The reference beam 41 coming from the reference-beam spatial light modulating unit 47 passes through the beam splitter 23 and the objective lens 24 and is incident on a hologram formed in the recording layer 50a of the holographic recording medium 50, thus reproducing data recorded on the medium. In other words, a diffracted beam 42 corresponding to the hologram is generated by the reference beam. The beam splitter 23 changes the traveling direction of the diffracted beam 42, so that a reconstructed beam (diffracted beam) 43 is applied to the image sensor 25. Since an electric signal from the image sensor 25 corresponds to the shape of the hologram, i.e., recorded data, the controller 60 (see FIG. 4) can reproduce the recorded data from the electric signal.

The holographic recording and reproducing apparatus (capable of performing both of recording and reproducing operations) includes components of both of the coaxial optical system 10 and the coaxial optical system 11. In other words, the apparatus has components similar to those of the coaxial optical system 11 to perform the recording and reproducing operations. During recording, the signal-beam spatial light modulating unit 46 and the reference-beam spatial light modulating unit 47, which surrounds the modulating unit 46, in the spatial light modulator 22 display a signal beam pattern and a reference beam pattern, respectively, as shown in FIG. 2. During reproducing, the reference-beam spatial light modulating unit 47 displays a reference beam pattern. The above-described whole black pattern in which a light beam is not transmitted is displayed in the area corresponding to the signal-beam spatial light modulating unit 46. Patterns displayed in the spatial light modulator 22 are controlled in accordance with a control signal supplied from the controller 60.

FIG. 4 schematically shows a holographic recording and reproducing apparatus 100 according to an embodiment, with focusing on an optical unit, serving as major part of the apparatus. The same reference numerals are assigned to the same components as those described previously and a description of the components is omitted.

The holographic recording and reproducing apparatus 100 includes a servo optical system 30. Reference numerals are assigned to major optical components constituting the servo optical system 30. The major components will be described in brief. A servo light source 28 emits a light beam for servo control (hereinafter, a servo light beam). The servo light beam has a wavelength different from that of a light beam for recording/reproducing (hereinafter, a recording/reproducing light beam) emitted from the laser source 20. The servo light beam having a longer wavelength than the recording/reproducing light beam, e.g., a red laser beam is used so that the servo light beam can be separated from the recording/reproducing light beam.

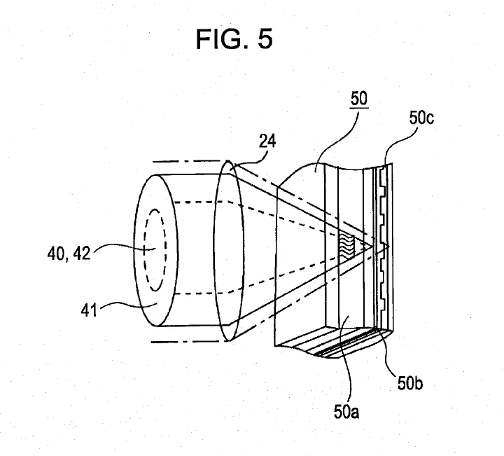

A beam splitter 27 is used for guiding light returned from the holographic recording medium 50 to a photodetector 29. The photodetector 29 includes a plurality of detector segments so as to meet, for example, the astigmatic method for focus servo control and meet the push-pull method for radial (tracking) servo control. A dichroic mirror 34 is an optical component shared between the servo optical system 30 and a recording/reproducing optical system and serves as a wavelength separating element for separating light into a servo light beam and a recording/reproducing light beam. A reflecting mirror 56 changes the traveling direction of each of the servo light beam and the recording/reproducing light beam to the objective lens 24. Further, the reflecting mirror 56 changes the traveling direction of a diffracted beam from an address groove 50c (refer to FIG. 5) of the holographic recording medium 50 and that of a diffracted beam from a hologram to the servo optical system 30 and the recording/reproducing optical system, respectively.

A spindle motor 51 rotates the holographic recording medium 50 having a shape similar to that of a conventional optical disk, such as a CD or DVD, such that the disk medium rotates about the center of the geometry thereof. The rotating position of the holographic recording medium 50 is controlled in accordance with a control signal from the controller 60.

The operation of the holographic recording and reproducing apparatus 100 is described in brief. First, the recording operation thereof is described.

A light beam emitted from the laser source 20 is incident on the spatial light modulator (SLM) 37. The spatial light modulator 37 has a structure different from that of the transmissive spatial light modulator 22 shown in FIGS. 1 and 2. The spatial light modulator 37 is of a reflective type which is designed such that whether a light beam is reflected or not (i.e., absorbed) is determined in each pixel. The transmissive spatial light modulator 22 and the reflective spatial light modulator 37 are intended for the same purpose to perform spatial light modulation on a light beam. The properties of a reference beam and a signal beam obtained by the reflective spatial light modulator 37 are exactly the same as those obtained by the transmissive spatial light modulator 22.

Patterns displayed on the spatial light modulator 37 are the same as those shown in FIG. 2. In other words, the spatial light modulator 37 also includes a signal-beam spatial light modulating unit 46 and a reference-beam spatial light modulating unit 47. In the spatial light modulator 37, in order to record data on the holographic recording medium 50, a signal beam pattern for generating a signal beam is displayed in the signal-beam spatial light modulating unit 46 on the basis of recording data and a reference beam pattern for generating a reference beam is displayed in the reference-beam spatial light modulating unit 47. In the holographic recording and reproducing apparatus 100 utilizing the coaxial method, the spatial light modulator 37 includes both of the signal-beam spatial light modulating unit 46 and the reference-beam spatial light modulating unit 47. The area of the spatial light modulator 22 is divided into two areas on the basis of a control signal from the controller 60 such that the units 46 and 47 are arranged on the same plane.

The signal beam and the reference beam pass through relay lenses 35 and 36, a phase mask 44, the beam splitter 23, relay lenses 38 and 39, and the dichroic mirror 34. The signal beam and the reference beam are reflected by the reflecting mirror 56 and are converged through the objective lens 24 so that the size of each beam is suitable for recording/reproducing. After that, the signal beam and the reference beam are applied to the holographic recording medium 50 such that the signal beam combines with the reference beam in the recording layer 50a (see FIG. 5) of the holographic recording medium 50 to form a hologram, so that the data is recorded. A relay lens actuator 45 for moving the relay lens 39 laterally in FIG. 4 is provided to appropriately set the formation point of an image formed by the reference beam or both of the signal beam and the reference beam modulated by the spatial light modulator 37. The relay lens actuator 45 is controlled in accordance with a signal from the controller 60.

In this case, the recording/reproducing light beam is controlled by a focus and radial servo system including the servo optical system 30 so that the light beam is focused on the recording layer in the holographic recording medium 50 and is located in a predetermined position in the radial direction. Further, the holographic recording medium 50 is controlled by a spindle servo system for controlling the angle of rotation of the spindle motor 51 so that the recording/reproducing light beam is applied to a predetermined position along a track perpendicular to the radial direction of the holographic recording medium 50. The controller 60 processes an electric signal from the photodetector 29, so that the above-described servo control is performed. The light beam from the servo optical system 30 is reflected by the dichroic mirror 34 and the reflecting mirror 56. The reflected light beam passes through the objective lens 24 and is applied to the holographic recording medium 50. On the other hand, the light beam from the recording/reproducing optical system passes through the dichroic mirror 34 and is reflected by the reflecting mirror 56. The reflected light beam passes through the objective lens 24 and is applied to the holographic recording medium 50. In the holographic recording and reproducing apparatus 100 using the coaxial method, all of a signal beam, a reference beam, and a diffracted beam pass through the objective lens 24.

In the holographic recording medium 50, the address groove 50c (refer to FIG. 5) for positioning a recording/reproducing light beam and a servo light beam is arranged. The servo optical system 30 has a structure similar to that of a servo optical system for known CDs and DVDs so that the positions of the recording/reproducing light beam and the servo light beam in the holographic recording medium 50 can be detected on the basis of an electrical signal from the photodetector 29. In other words, the interrelation between the recording/reproducing light beam and the servo light beam is uniquely defined by the relation between the arrangement of the optical elements constituting the recording/reproducing optical system and that of the optical elements constituting the servo optical system 30. The above-described focus and radial servo system and spindle servo system determine the positional relationship between the servo light beam and the holographic recording medium 50, so that the positional relationship between the recording/reproducing light beam and the holographic recording medium 50 can be controlled.

In other words, the photodetector 29 in the servo optical system 30 detects a focus error signal and a tracking error signal. On the basis of the respective error signals, a focus tracking servo circuit (not shown) disposed in the controller 60 controls an objective lens actuator 54, which includes a focus actuator and a tracking actuator, to displace the objective lens 24 in the directions F and T shown in FIG. 4 so that a target position in the holographic recording medium 50 is irradiated with the servo light beam and the recording/reproducing light beam.

In the above description, the holographic recording and reproducing apparatus 100 in FIG. 4 has both of a recording function and a reproducing function. In the holographic recording and reproducing apparatus 100, part related to the reproducing function, e.g., the image sensor 25 may be eliminated. In other words, a holographic recording apparatus having no reproducing function may be provided. Further, in the holographic recording and reproducing apparatus 100, part related to the recording function, e.g., the signal-beam spatial light modulating unit 46 may be removed. In other words, a holographic reproducing apparatus having no recording function may be provided.

Structure of Holographic Recording Medium

FIG. 5 schematically shows the structure (cross section) of the holographic recording medium 50 and further schematically shows the entrance of the signal beam 40, the diffracted beam 42, the reference beam 41, and the servo light beam into the objective lens 24. Referring to FIG. 5, the signal beam 40 and the diffracted beam 42 correspond to a portion enclosed by a dash line. The reference beam 41 corresponds to a portion between the dash line and a solid line. The servo light beam corresponds to a portion enclosed by an alternative long and short dash line. The holographic recording medium 50 includes the recording layer 50a, a reflecting film 50b for the recording/reproducing light beam, and the address groove 50c. The address groove 50c is a single spiral groove having projections and recessions. The shape of the groove is deformed so as to be optically readable. A position in the holographic recording medium 50 can be specified on the basis of the state of the deformation. As for the deformation of the shape of the groove, for example, the groove may include discrete pits or may serpentine.

During recording, a hologram is formed in the recording layer 50a in accordance with an interference fringe pattern caused by the interference between the signal beam 40 and the reference beam 41. During reproducing, only the reference beam 41 is applied to the hologram. The reflecting film 50b reflects the beam and the objective lens 24 allows the reflected beam to pass therethrough, so that the diffracted beam 42 corresponding to the hologram appears in substantially the same area as that of the signal beam 40 during recording. On the other hand, the servo light beam passes through the reflecting film 50b having wavelength selectivity and is reflected by an aluminum reflecting film in which the address groove 50c is arranged. The photodetector 29 in the servo optical system 30 detects an electrical signal on the same principle as that for CDs and DVDs. On the basis of the electrical signal, the controller 60 obtains error signals necessary for the above-described focus servo control, radial servo control, and spindle motor rotation control, and an address signal for specifying a light-beam irradiation position in the recording layer 50a of the holographic recording medium 50.

Methods for Recording and Reproducing

Methods for holographic recording and reproducing using the above-described holographic recording and reproducing apparatus 100 are now described below. Although there are various methods for holographic recording and reproducing, some of typical methods are described below.

First Method for Recording and Reproducing

A first method for holographic recording and reproducing according to an embodiment is described below. In the following description, a recording process will be first explained and a reproducing process will be subsequently described.

First, the holographic recording medium 50 is inserted into the holographic recording and reproducing apparatus 100. Subsequently, the controller 60 performs focus servo control and tracking servo control on the holographic recording medium 50 using the servo optical system. The controller 60 also controls the rotation of the spindle motor 51.

After the operation for the servo systems is started as described above, the operation for detecting a predetermined area for recording in the holographic recording medium 50 is performed. This operation is performed with a servo light beam. The controller 60 reads out an address to specify the position of the holographic recording medium 50 from the address groove 50c, the address being previously recorded in the holographic recording medium 50. After that, the controller 60 jumps a servo light beam in the transverse direction across the track using the tracking servo system so that the spot of the servo light beam is located in the predetermined area for recording in the holographic recording medium 50 and positions the beam spot in a track portion where the predetermined area is arranged.

As for positioning in the track direction (along the groove) perpendicular to the above-described transverse direction, when reading an address indicating a target predetermined area, the controller 60 stops the spindle motor 51 and arranges the spot of the servo light beam in the target address. As described above, the position of the servo light beam is related to that of a light beam for recording data onto the holographic recording medium or reproducing data recorded on the medium. Therefore, a hologram can be formed in a predetermined area and holographically recorded information can be read from the predetermined area with the assistance of the servo light beam.

After the predetermined area in the holographic recording medium 50 is specified (that is, the beam spot is positioned), the operation proceeds to the holographic recording operation. The controller 60 controls the spatial light modulator 37 to display a first reference beam pattern and a first signal beam pattern, which is based on first recording data. Subsequently, the controller 60 controls the laser source 20 to emit a light beam. Consequently, a reference beam interferes with a signal beam in the holographic recording medium 50, so that a first hologram based on an interference fringe pattern is formed in the recording layer 50a.

In addition, the controller 60 controls the spatial light modulator 37 to display a second reference beam pattern and a second signal beam pattern, which is based on second recording data. Subsequently, the controller 60 controls the laser source 20 to emit a light beam. Consequently, a reference beam interferes with a signal beam in the holographic recording medium 50, so that a second hologram based on an interference fringe pattern is formed in the recording layer 50a.

Further, the controller 60 controls the spatial light modulator 37 to display a third reference beam pattern and a third signal beam pattern, which is based on third recording data. Subsequently, the controller 60 controls the laser source 20 to emit a light beam. Consequently, a reference beam interferes with a signal beam in the holographic recording medium 50, so that a third hologram based on an interference fringe pattern is formed in the recording layer 50a.

As described above, the controller 60 controls the spatial light modulator 37 to sequentially display different reference beam patterns and different signal beam patterns based on the respective recording data units and controls the laser source 20 to emit a light beam. Consequently, the different reference beams interfere with the signal beams based on the recording data units, respectively, in the holographic recording medium 50. Thus, the respective holograms are formed in the same area, specified as the predetermined area, in the recording layer 50a such that the holograms overlap one another. In the following description, forming and reconstructing holograms in the same area using difference reference beam patterns will be simply called multiplexing. The number of multiplexed holograms depends on restrictions on reference beam patterns. The number of multiplexed holograms will be described in detail after the description regarding a reproducing process.

The process of reproducing recorded data from a plurality of holograms formed in the same area as described above is explained below.

Similar to the recording process, the holographic recording medium 50 is inserted into the holographic recording and reproducing apparatus 100 and the controller 60 performs focus servo control and tracking servo control on the holographic recording medium 50 using the servo optical system and also controls the rotation of the spindle motor 51. Further, the controller 60 arranges the spot of a servo light beam in a predetermined position in the holographic recording medium 50 and applies a light beam for reproducing data recorded on the holographic recording medium to the predetermined area in a manner similar to the recording process.

After the predetermined area in the holographic recording medium 50 is specified (that is, the beam spot is positioned), the operation proceeds to the operation of reproducing data recorded on the holographic recording medium 50. The controller 60 controls the spatial light modulator 37 to display the first reference beam pattern. Subsequently, the controller 60 controls the laser source 20 to emit a light beam. Consequently, the holographic recording medium 50 is irradiated with the first reference beam, thus generating a first diffracted beam. The first diffracted beam is finally brought to the image sensor 25, thus forming a first reproduced image on the image sensor 25. The first reproduced image is formed as a two-dimensional pattern on the image sensor 25. The controller 60 allows an A/D converter (not shown) to capture analog information based on light and dark portions of the two-dimensional pattern as one-dimensional time-series data from the image sensor 25 and convert the analog information into binary data pieces each indicating a value of “1” or “0” on the basis of a threshold value. Further, the controller 60 performs error correction on each block code corresponding to one symbol described above, thus generating first reproduced data.

In addition, the controller 60 controls the spatial light modulator 37 to display the second reference beam pattern. Subsequently, the controller 60 controls the laser source 20 to emit a light beam. Consequently, the holographic recording medium 50 is irradiated with the second reference beam, thus generating a second diffracted beam. The second diffracted beam is finally brought to the image sensor 25, thus forming a second reproduced image on the image sensor 25. The second reproduced image is formed as a two-dimensional pattern on the image sensor 25. The controller 60 captures analog information based on light and dark portions of the two-dimensional pattern as one-dimensional time-series data from the image sensor 25 and converts the analog information into binary data pieces each indicating a value of “1” or “0”. Further, the controller 60 performs error correction on each block code corresponding to one symbol described above, thus generating second reproduced data.

Furthermore, the controller 60 controls the spatial light modulator 37 to display the third reference beam pattern. Subsequently, the controller 60 controls the laser source 20 to emit a light beam. Consequently, the holographic recording medium 50 is irradiated with the third reference beam, thus generating a third diffracted beam. The third diffracted beam is finally brought to the image sensor 25, thus forming a third reproduced image on the image sensor 25. The third reproduced image is formed as a two-dimensional pattern on the image sensor 25. The controller 60 captures analog information based on light and dark portions of the two-dimensional pattern as one-dimensional time-series data from the image sensor 25 and converts the analog information into binary data pieces each indicating a value of “1” or “0”. Further, the controller 60 performs error correction on each block code corresponding to one symbol described above, thus generating third reproduced data.

As described above, the controller 60 sequentially displays the different reference beam patterns on the spatial light modulator 37, thus sequentially generating the respective reproduced data units.

When the first reproduced data exactly coincides with the first recording data, the second reproduced data completely coincides with the second recording data, the third reproduced data exactly coincides with the third recording data, and the nth (1≦n≦N) reproduced data completely coincides with the nth recording data on condition that the number of multiplexing times is N, a plurality of holograms are multiplexed in the same area. Criteria which reference beam patterns need to meet in order to make each reproduced data completely coincide with the corresponding recording data is described in detail below.

A first case where a first reference beam pattern is identical with a second reference beam pattern will be considered as an extreme example. A first hologram is formed using the first reference beam pattern and a first signal beam pattern based on first recording data, a second hologram is formed using the second reference beam pattern and a second signal beam pattern based on second recording data that is different from the first recording data, and the first and second holograms are recorded in the same area. First reproduced data obtained when a first reference beam is applied to this area where the first and second holograms are formed is identical to second reproduced data obtained when a second reference beam (i.e., the first reference beam) is applied to the same area. The first reproduced data does not coincide with the first recording data and the second reproduced data does not coincide with the second recording data.

A second case where a first reference beam pattern is uncorrelated with a second reference beam pattern will be considered. In this case, first reproduced data obtained when a first reference beam is applied to an area where respective holograms are formed is different from second reproduced data obtained when a second reference beam is applied to the same area. The first reproduced data coincides with first recording data and the second reproduced data coincides with second recording data.

A third case where a first reference beam pattern is not uncorrelated with a second reference beam pattern but the degree of correlation is low will be considered. For example, it is assumed that certain pixels in the first reference beam pattern and the same pixels in the second reference beam pattern are white pixels that reflect a light beam and the number of white pixels in each reference beam pattern is smaller than the total number of pixels reflecting a light beam. In this case, information obtained from a pixel, corresponding to each white pixel, in the image sensor 25 includes a mixture of information obtained from a first hologram and that obtained from a second hologram. In other words, first reproduced data contains not only first recording data but also part of second recording data as a noise and second reproduced data contains not only the second recording data but also part of the first recording data as a noise, leading to a reduction in the S/N (signal-to-noise) ratio of a reproduced signal. However, since the holographic recording and reproducing apparatus 100 according to the embodiment uses an error correction method, the apparatus can completely reproduce the first recording data from the first reproduced data and reproduce the second recording data from the second reproduced data so long as error correction can be performed.

The above-described three cases, i.e., the first case where the first and second reference beam patterns are identical with each other, the second case where the first reference beam pattern is uncorrelated with the second reference beam pattern, and the third case where the first reference beam pattern is not identical and uncorrelated with the second reference beam pattern are related to multiplexing holograms in the same area using two reference beam patterns. When three or more reference beam patterns are used, similar results are obtained.

As described above, the best recording and reproducing characteristics, i.e., the optimal S/N ratio can be obtained by uncorrelation between a plurality of reference beam patterns. Obviously, an increase in the number of multiplexing times, i.e., the number of reference beam patterns leads to a reduction in the white rate. When the white rate decreases, the level of a reference beam decreases, so that the intensity of an obtained diffracted beam becomes low. Unfortunately, the level of a reproduced signal (i.e., the level of a signal S) obtained from the image sensor 25 becomes low. This results in a reduction in the S/N ratio. Therefore, the number of multiplexing times is restricted.

According to the above-described method for holographic recording and reproducing, a plurality of holograms can be recorded in the same area and the good recording and reproducing characteristics can be obtained. Therefore, this method can increase the density of information recorded on a holographic recording medium as compared with conventional multiplexing methods, e.g., shift multiplexing recording. During recording, it is unnecessary to change the position of a light beam, which contains a signal beam and a reference beam, relative to a holographic recording medium each time a hologram is formed. During reproducing, it is unnecessary to change the position of a reference beam relative to the holographic recording medium each time a signal is reproduced from the corresponding hologram. Advantageously, a mechanism of the recording and reproducing apparatus can be simplified and be controlled easily. Further, since it is unnecessary to change the position of a light beam relative to a holographic recording medium, recording/reproducing rate (throughput) can be increased. The above-described recording and reproducing processes are sequentially controlled by the controller 60.

Second Method for Recording and Reproducing

As described in the background of the related art, the shift multiplexing recording method is used for holographic recording and reproducing. In conventional shift multiplexing recording, a plurality of holograms based on a plurality of recording data units are sequentially recorded in a single area (the same area) using a single reference beam pattern such that the holograms overlap each other. In a second method for holographic recording and reproducing according to an embodiment, there is no problem regarding the use of shift multiplexing recording. The second method performs shift multiplexing recording while changing a reference beam pattern.

Generally, different reference beam patterns are sequentially generated cyclically. In this method, the same reference beam pattern is generated in the next cycle. In this instance, so long as holographic recording is repeated such that an area where a hologram is formed using a reference beam pattern in the preceding cycle is not overlapped with another area where another hologram is formed using the same reference beam pattern in the current cycle, simultaneous detection of reproduced data units from two or more holograms using the same reference beam pattern can be prevented even when few reference beam patterns are used. Shift multiplexing recording is repeated in the above-described manner, so that a large amount of information can be recorded and good recording and reproducing characteristics can be obtained. Further, since the amount of shift of the holographic recording medium 50 can be continuously set to a very small distance, the movement of the medium can be easily controlled.

During reproducing, reference beam patterns are sequentially changed while the holographic recording medium 50 is being moved by the very small amount of shift, so that recording data units can be reproduced from respective holograms. The above-described recording and reproducing processes are sequentially controlled by the controller 60.

In other words, since the shift multiplexing recording method according to the present embodiment uses different reference beam patterns, an overlapping area shared by a plurality of holograms formed in shift multiplexing recording can be larger than that in conventional shift multiplexing recording. In other words, the overlapping area in shift multiplexing recording is increased, thus increasing the recording density. The combination of the degree of shift of a hologram forming area and the degree of correlation between a plurality of reference beam patterns (i.e., the ratio of the number of common pixels, which reflect a light beam, between different reference beam patterns to the total number of pixels reflecting a light beam) is appropriately adjusted, so that the density of information recorded in a holographic recording medium can be increased.

Third Method for Recording

A third method for holographic recording according to an embodiment is the combination of the conventional shift multiplexing recording method using a fixed reference beam pattern and the above-described first method of forming a plurality of holograms in a single area using different reference beam patterns.

Recording is performed in a manner similar to the conventional shift multiplexing recording. In other words, the spatial light modulator 37 displays a reference beam pattern (first reference beam pattern) and a (1, 1)th signal beam pattern based on (1, 1)th recording data. Subsequently, the laser source 20 emits a laser beam, so that a first reference beam is obtained from the first reference beam pattern and a (1, 1)th signal beam is obtained from the (1, 1)th signal beam pattern. A (1, 1)th hologram is formed by an interference fringe pattern caused between the first reference beam and the (1, 1)th signal beam in the recording layer 50a of the holographic recording medium 50. As for the above-described operation, the controller 60 in the holographic recording and reproducing apparatus 100 controls the spatial light modulator 37 and the laser source 20 to perform this operation.

Subsequently, the controller 60 controls the spindle motor 51 to rotate the holographic recording medium 50 in the rotating direction of the spindle motor 51 (i.e., in the direction along the track). The amount of movement of the medium by rotation is equivalent to the amount of shift thereof in shift multiplexing recording. The spatial light modulator 37 displays the first reference beam pattern and a (1, 2)th signal beam pattern based on (1, 2)th recording data. Subsequently, the laser source 20 emits a laser beam, so that the first reference beam is obtained from the first reference beam pattern and a (1, 2)th signal beam is obtained from the (1, 2)th signal beam pattern. A (1, 2)th hologram is formed by an interference fringe pattern caused between the first reference beam and the (1, 2)th signal beam in the recording layer 50a of the holographic recording medium 50. As for the above-described operation, the controller 60 in the holographic recording and reproducing apparatus 100 controls the spatial light modulator 37 and the laser source 20 to perform this operation.

The above-described process is repeated while the holographic recording medium 50 is being moved in the direction along the track until a (1, M)th hologram is formed. The above-described process is the same as the conventional shift multiplexing recording.

The present embodiment differs from the conventional shift multiplexing recording in that a hologram is formed in the same area as that where another hologram has been recorded as described above using a different reference beam pattern. In other words, the following multiplexing recording process is performed in addition to the above-described shift multiplexing recording.

The controller 60 controls the spindle motor 51 to rotate the holographic recording medium 50 in the direction along the track. When the holographic recording medium 50 is rotated one turn, a target area in a different track segment is adjacent to the position in which the (1, 1)th hologram is formed. At that time, so-called one track back jump is performed so that a hologram can be recorded in the same position where the (1, 1)th hologram is formed. The spatial light modulator 37 displays a second reference beam pattern and a (2, 1)th signal beam pattern corresponding to (2, 1)th recording data. Subsequently, the laser source 20 emits a laser beam, so that a second reference beam is obtained from the second reference beam pattern and a (2, 1)th signal beam is obtained from the (2, 1)th signal beam pattern. A (2, 1)th hologram is formed by an interference fringe pattern caused between the second reference beam and the (2, 1)th signal beam in the recording layer 50a of the holographic recording medium 50. As for the above-described operation, the controller 60 in the holographic recording and reproducing apparatus 100 controls the spatial light modulator 37 and the laser source 20 to perform this operation. Consequently, the (2, 1)th hologram can be formed in the same area as that where the (1, 1)th hologram is formed.

Subsequently, the controller 60 controls the spindle motor 51 to rotate the holographic recording medium 50 in the rotating direction of the spindle motor 51 (i.e., the direction along the track). The amount of movement of the medium by rotation is equivalent to the amount of shift thereof in shift multiplexing recording. The spatial light modulator 37 displays a second reference beam pattern and a (2, 2)th signal beam pattern corresponding to (2, 2)th recording data. The laser source 20 emits a laser beam, so that the second reference beam is obtained from the second reference beam pattern and a (2, 2)th signal beam is obtained from the (2, 2)th signal beam pattern. Thus, a (2, 2)th hologram is formed by an interference fringe pattern caused between the second reference beam and the (2, 2)th signal beam in the recording layer 50a of the holographic recording medium 50. As for the above-described operation, the controller 60 of the holographic recording and reproducing apparatus 100 controls the spatial light modulator 37 and the laser source 20 to perform this operation. Consequently, the (2, 2)th hologram can be formed in the same area as that where the (1, 2)th hologram is formed.

The above-described process is repeated while the holographic recording medium 50 is being moved in the direction along the track until a (2, M)th hologram is formed. After that, one track back jump is further repeated so that the (1, 1)th to (N, M)th holograms are formed. Consequently, N holograms are formed in each single area. Since shift multiplexing recording is performed, the total number of formed holograms is M×N. As described above, N represents the number of holograms formed in the same single area using different reference beam patterns and M represents the number of holograms formed in one track segment corresponding to one turn of the holographic recording medium. Generally, the number M in an outer track segment is larger than that in an inner track segment.

In the above-described case, most preferably, uncorrelation between the N reference beam patterns increases the S/N ratio, thus improving the recording/reproducing characteristics. On the other hand, the number N that realizes uncorrelation is restricted. The larger the number N, the lower the white rate. Since the level of a signal S decreases with decreasing the white rate, thus reducing the S/N ratio. Therefore, the number N, representing the number of multiplexed holograms in a single area, and the value of the white rate should be appropriately determined. Alternatively, the recording density in the holographic recording medium 50 can be appropriately adjusted by increasing the white rate to the extent where error correction can be performed in the use of different reference beam patterns which are not uncorrelated with one another but have low correlation therebetween.

Fourth Method for Recording

A fourth method for holographic recording according to an embodiment is similar to the above-described third method in arrangement of multiplexed holograms. The fourth method according to this embodiment differs from the third method in that N holograms are multiplexed in a single area, the holographic recording medium 50 is shifted in the direction along the track, and N holograms are recorded in a single area that overlaps another single area where different N holograms have been formed. A recording process according to the present embodiment is described in detail hereinbelow.

The spatial light modulator 37 displays a first reference beam pattern and a (1, 1)th signal beam pattern corresponding to (1, 1)th recording data. Subsequently, the laser source 20 emits a laser beam, so that a first reference beam is obtained from the first reference beam pattern and a (1, 1)th signal beam is obtained from the (1, 1)th signal beam pattern. A (1, 1)th hologram is formed by an interference fringe pattern caused between the first reference beam and the (1, 1)th signal beam in the recording layer 50a of the holographic recording medium 50. As for the above-described operation, the controller 60 of the holographic recording and reproducing apparatus 100 controls the spatial light modulator 37 and the laser source 20 to perform this operation.

The spatial light modulator 37 displays a second reference beam pattern and a (2, 1)th signal beam pattern corresponding to (2, 1)th recording data. Subsequently, the laser source 20 emits a laser beam, so that a second reference beam is obtained from the second reference beam pattern and a (2, 1)th signal beam is obtained from the (2, 1)th signal beam pattern. A (2, 1)th hologram is formed by an interference fringe pattern caused between the second reference beam and the (2, 1)th signal beam in the recording layer 50a of the holographic recording medium 50. As for the above-described operation, the controller 60 of the holographic recording and reproducing apparatus 100 controls the spatial light modulator 37 and the laser source 20 to perform this operation.

The (1, 1)th to (N, 1)th holograms, i.e., N holograms are formed in a single area in this manner. After that, the controller 60 controls the spindle motor 51 to rotate the holographic recording medium 50 in the rotating direction of the spindle motor 51 (i.e., the direction along the track). The amount of movement of the medium by rotation is equivalent to the amount of shift thereof in shift multiplexing recording. The spatial light modulator 37 displays the first reference beam pattern and a (1, 2)th signal beam pattern corresponding to (1, 2)th recording data. Subsequently, the laser source 20 emits a laser beam, so that the first reference beam is obtained from the first reference beam pattern and a (1, 2)th signal beam is obtained from the (1, 2)th signal beam pattern. A (1, 2)th hologram is formed by an interference fringe pattern caused between the first reference beam and the (1, 2)th signal beam in the recording layer 50a of the holographic recording medium 50. As for the above-described operation, the controller 60 of the holographic recording and reproducing apparatus 100 controls the spatial light modulator 37 and the laser source 20 to perform this operation.

As described above, after N holograms are sequentially formed in a single area, the holographic recording medium 50 is moved in the direction along the track, and N holograms are sequentially formed in another single area. Such a process is repeated so that the (1, 1)th to (N, M)th holograms are formed. Since N holograms are formed in each single area and shift multiplexing recording is performed, the total number of formed holograms is M×N. In this method, M×N holograms can be recorded without performing one track back jump (N−1) times in the foregoing embodiment related to the third method. In this instance, N represents the number of holograms formed in a single area using different reference beam patterns and M represents the number of holograms formed in a track segment corresponding to one turn of the holographic recording medium in a manner similar to the third method.

In the above-described method, similar to the third method, most preferably, uncorrelation between the N reference beam patterns increases the S/N ratio, thus improving the recording/reproducing characteristics. On the other hand, the number N that realizes uncorrelation is restricted. The larger the number N, the lower the white rate. Since the level of a signal S decreases with decreasing the white rate, thus reducing the S/N ratio. Therefore, the number N representing the number of multiplexed holograms in a single area and the value of the white rate should be appropriately determined. Alternatively, the recording density in the holographic recording medium 50 can be appropriately adjusted by increasing the white rate to the extent where error correction can be performed in the use of different reference beam patterns which are not uncorrelated with one another but have low correlation therebetween.

A method of reproducing data from holograms formed by the third or fourth method is described below. Physical arrangement of holograms formed according to the above-described third method is identical in principle to that according to the fourth method. However, when time-series signals are recorded, those methods differ from each other in the order of formation of holograms. Therefore, descriptions of information contained in holograms formed by the third method are different from those by the fourth method. Although the third and fourth methods differ from each other in the order of formation of holograms, identical information can be stored in the same position in the use of any of those methods so long as the controller 60 controls recording positions in each of which time-series recording data is recorded as a hologram. Similarly, the controller 60 permits free arrangement of information not only during recording but also during reproducing. Regarding reproducing of data from holograms, it is therefore unnecessary to distinguish between the third and fourth methods.

According to one reproducing method, a reference beam pattern (e.g., a first reference beam pattern) is displayed, shift-multiplexed holograms are sequentially reconstructed while the spindle motor 51 is gradually rotated M times such that the motor is shifted by 1/M of one turn in each rotation, a target position is returned to the head of the above-described shift multiplexing recording areas by one track back jump, another reference beam pattern (e.g., a second reference beam pattern) is displayed, shift-multiplexed holograms are sequentially reconstructed while the spindle motor 51 is gradually rotated M times such that the motor is shifted by 1/M of one turn in each rotation, and a target position is returned to the head of the recording areas by one track back jump. The above-described process is repeated N times, so that all of recording data units can be read from N×M holograms.

According to another reproducing method, a reference beam pattern (e.g., a first reference beam pattern) is displayed, recording data corresponding to the first reference beam pattern is reproduced from a hologram formed in an area, another reference beam pattern (e.g., a second reference beam pattern) is displayed, and recording data corresponding to the second reference beam pattern is reproduced from another hologram formed in the same area. Such a process is repeated N times, thus reproducing N data units recorded in the same area. The spindle motor 51 is gradually rotated by the amount of shift and N recording data units corresponding to N reference beam patterns are reproduced. Such a process is repeated M times, so that all of recording data units can be reproduced from N×M holograms.

The foregoing third recording method may be used in combination with any of the above-described two reproducing methods and the foregoing fourth recording method may be used in combination with any of the two reproducing methods. During recording, the order of recording (i.e., from which position hologram formation should start in the holographic recording medium 50) may be determined in accordance with the recording method. During reproducing, the order of reproducing (i.e., from which position hologram reconstruction should start in the holographic recording medium 50) may be determined in accordance with the reproducing method. Therefore, the recording methods and the reproducing methods can be appropriately used in combination, thus reducing a burden on the controller 60. Advantageously, for example, when the recording and reproducing methods are applied to a data storage device, higher throughput can be easily realized. When those methods are applied to consumer devices for recording video images, various trick plays, such as fast-forward play and multilingual play, can be readily performed.

As described above, the holographic recording and reproducing apparatus 100 according to one embodiment can record more information than ever before in the holographic recording medium 50. In terms of holographic recording media, this means that the structure of the holographic recording medium 50 can be made different from that of a conventional holographic recording medium. For example, in the use of the conventional shift multiplexing recording method described in the background of the related art, the distance between adjacent groove segments (or the width of the groove) in the holographic recording medium 50 is set to be very narrow in order to increase the recording density in the direction across the track. In other words, shift multiplexing is performed not only in the direction along the track but also in the direction across the track (i.e., the radial direction) in the conventional shift multiplexing recording method. In this case, since a groove is formed by a stamping process, formation of a groove having a certain width or narrower leads to an increase in manufacturing cost.

On the other hand, in any of the methods of multiplexing and recording data using different reference beam patterns according to the above-described embodiments, the good S/N ratio is obtained during reproducing recording data from a formed hologram. Advantageously, the number of multiplexing times can be remarkably increased as compared to that in the conventional shift multiplexing recording method. In other words, it results in low consumption of M/# in recording, so that an extremely large amount of data can be recorded.

Experimental Results

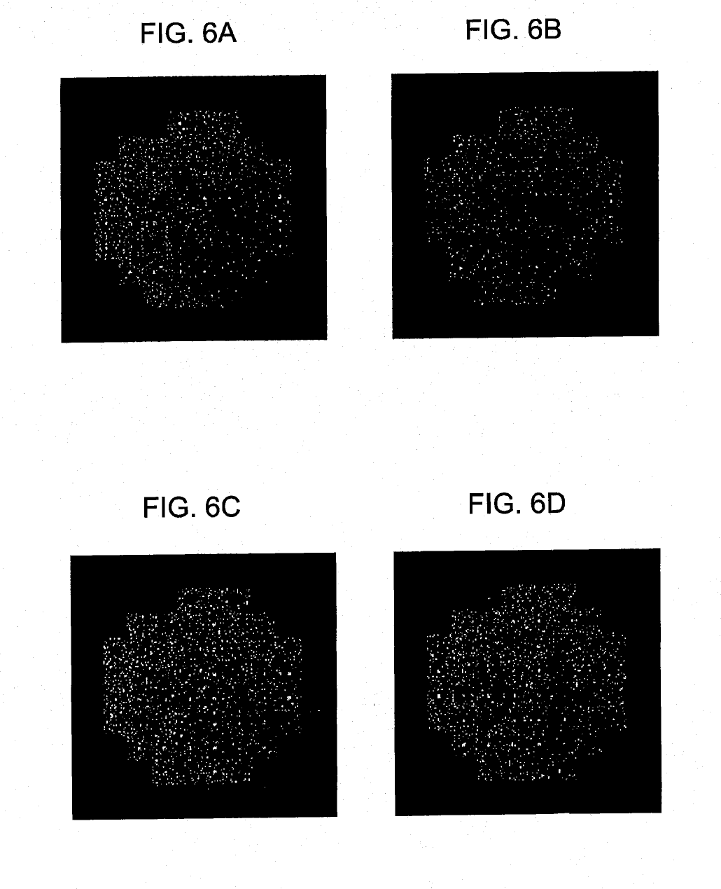

Results of recording and reproducing by the above-described first method will be described as experimental results with reference to FIGS. 6A to 6D. FIGS. 6A to 6D each show a reproduced image generated in the image sensor 25 after multiplexing.

As for the reproduced image shown in FIG. 6A, a first hologram was formed using a first reference beam pattern and a first signal beam pattern, a diffracted beam was obtained using a first reference beam, and this image was reproduced in the image sensor 25. In this case, a symbol error occurred in only one symbol among 1632 symbols in total in recording data corresponding to one page.

As for the reproduced image shown in FIG. 6B, five holograms were formed in a single area using first to five reference beam patterns and first to five signal beam patterns in such a manner that the first hologram was formed using the first reference and signal beam patterns, the second hologram was formed using the second reference and signal beam patterns, and so on. After that, a diffracted beam was obtained using a fifth reference beam and this image was reproduced in the image sensor 25. In this case, symbol errors occurred in two symbols among 1632 symbols in total of recording data corresponding to one page.

As for the reproduced image shown in FIG. 6C, ten holograms were formed in a single area using first to tenth reference beam patterns and first to tenth signal beam patterns in such a manner that the first hologram was formed using the first reference and signal beam patterns, the second hologram was formed using the second reference and signal beam patterns, and so on. After that, a diffracted beam was obtained using a tenth reference beam and this image was reproduced in the image sensor 25. In this case, symbol errors occurred in 13 symbols among 1632 symbols in total of recording data corresponding to one page.

As for the reproduced image shown in FIG. 6D, 16 holograms were formed in a single area using first to sixteenth reference beam patterns and first to sixteenth signal beam patterns in such a manner that the first hologram was formed using the first reference and signal beam patterns, the second hologram was formed using the second reference and signal beam patterns, and so on. After that, a diffracted beam was obtained using a sixteenth reference beam and this image was reproduced in the image sensor 25. In this case, symbol errors occurred in 53 symbols among 1632 symbols in total of recording data corresponding to one page.

In the recording and reproducing results shown in FIGS. 6A to 6D, the white rate of each reference beam pattern was 1/16 and the first to sixteenth reference beam patterns were uncorrelated with one another.

As will be understood from the above-described results, the error rate is sufficiently low even when 16 holograms are multiplexed and formed in a single area. Recording data can be completely reproduced using error correction.

Encryption

The above-described method for holographic recording and reproducing can be applied to encryption. In other words, an only recording data unit corresponding to one of multiplexed and formed holograms is significant data (information recording data) and recording data units corresponding to the other holograms are data (encryption recording data) used for encrypting the recording data. A reference beam used upon recording the information recording data is used to reproduce the information recording data. It is difficult to reproduce the recording data without using the reference beam. Therefore, encryption is achieved. When multiplexing is not performed, information recording data can be reproduced using a reference beam pattern used upon recording the information recording data, an all-white reference beam pattern, in which all of pixels in the reference-beam spatial light modulating unit 47 of the spatial light modulator 37 reflect a light beam, or a random reference beam pattern. When multiplexing is performed as described above, recording data can be reproduced using a diffracted beam obtained only when the same reference beam pattern as that used upon recording is used. In other words, the effect of encryption can be obtained.

Experimental Examples of Encryption

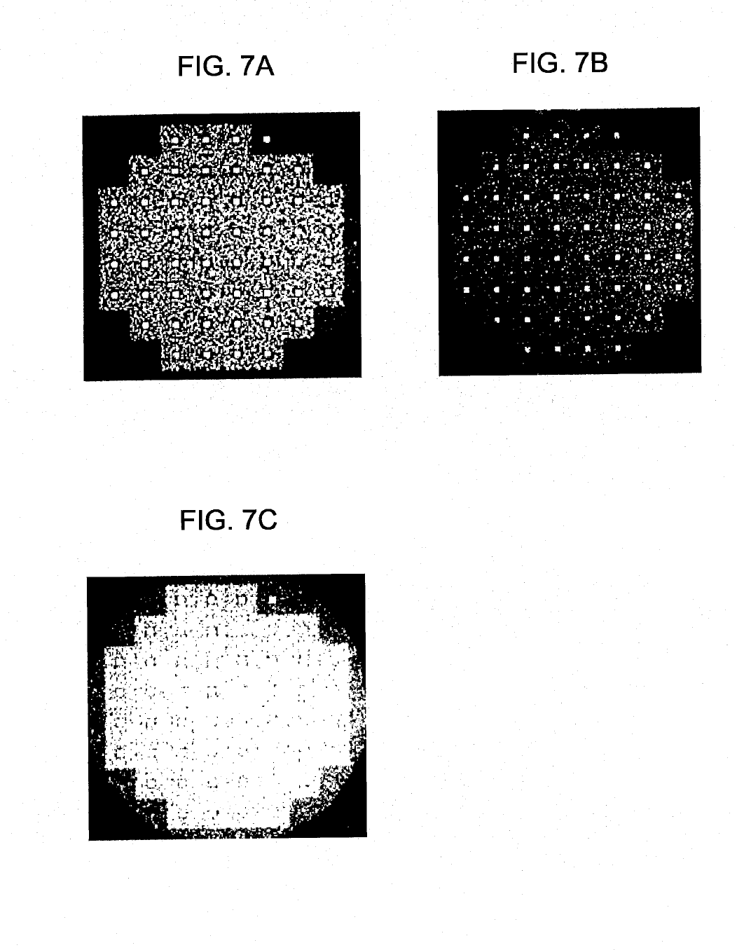

Experimental results related to the above-described effect of encryption will be described with reference to FIGS. 7A to 7C. FIGS. 7A to 7C each show a reproduced image generated in the image sensor 25 after multiplexing. In this instance, three reference beam patterns were used. The white rate of each reference beam pattern was 1/16 and those reference beam patterns were uncorrelated with one another. Information recording data (significant recording data) corresponding to one page and encryption recording data (recording data used for encryption) corresponding to two pages, i.e., recording data units of three pages in total are multiplexed and recorded in a single area in the holographic recording medium 50.

FIG. 7A shows an image reproduced in the image sensor 25 using a reference beam used upon recording the information recording data. In this case, symbol errors occurred in 15 symbols among 1632 symbols in total of the recording data corresponding to one page.

FIG. 7B shows an image reproduced in the image sensor 25 using a random reference beam pattern. In this case, symbol errors occurred in 1296 symbols among 1632 symbols in total of the recording data corresponding to one page.

FIG. 7C shows an image reproduced in the image sensor 25 using an all-white reference beam pattern. In this case, symbols errors occurred in 1398 symbols among 1632 symbols in total of the recording data corresponding to one page.

As described above, the information recording data can be reproduced only when the same reference beam pattern as that used upon recording the information recording data, therefore, the same reference beam is used. Since a person who does not know the reference beam, i.e., the reference beam pattern used upon recording, the person is not permitted to reproduce the information recording data. Advantageously, the effect of encryption can be obtained.

Other Experimental Results

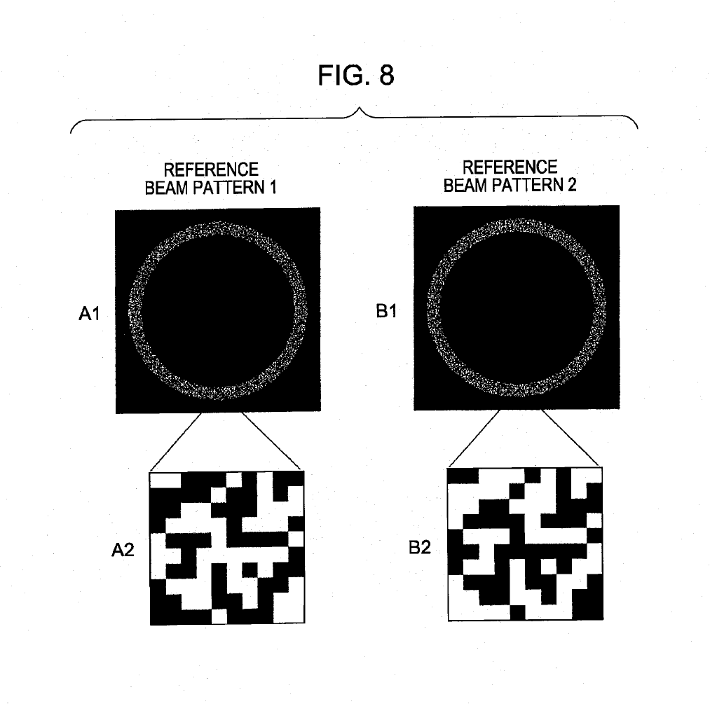

Results of recording and reproducing using a technique for shift multiplexing will be described as experimental results with reference to FIGS. 8 to 14. An apparatus similar to the holographic recording and reproducing apparatus 100 was used. FIG. 8 shows examples of reference beam patterns displayed in the reference-beam spatial light modulating unit 47. Referring to FIG. 8, part A1 shows a reference beam pattern 1, serving as a first reference beam pattern. Part A2 is an enlarged view of part of the reference beam pattern 1 of part A1. Part B1 shows a reference beam pattern 2, serving as a second reference beam pattern. Part B2 is an enlarged view of part of the reference beam pattern 2 of part B1. As will be understood from the comparison between part A2 and part B2 in FIG. 8, pixels are inverted (white pixels are black and vice versa) between the two patterns. In other words, the reference beam pattern 1 is uncorrelated with the reference beam pattern 2. Each reference beam pattern is a random pattern in which white pixels and black pixels are spatially arranged at random.

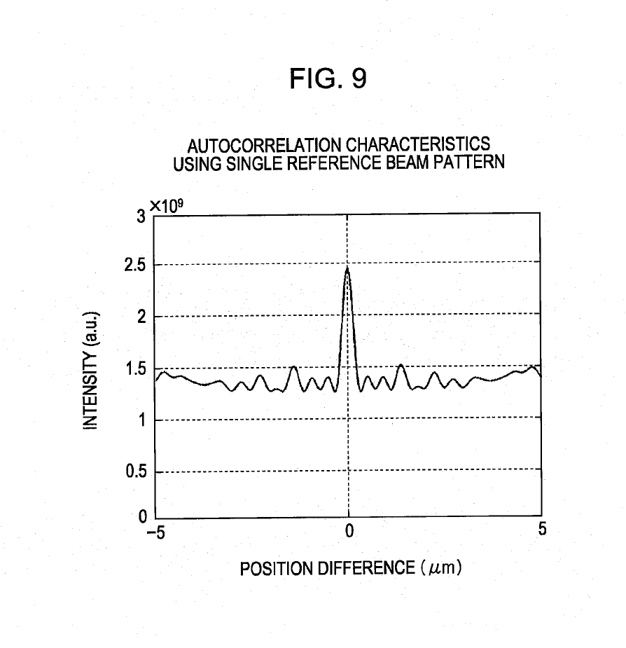

FIG. 9 shows the spatial autocorrelation function of diffraction fringes formed by a reference beam based on the reference beam pattern 1 and a signal beam based on an appropriate signal beam pattern (not shown), the spatial autocorrelation function being obtained by numerical analysis. In other words, FIG. 9 shows the value (intensity) of the autocorrelation function, serving as spatial convolution, plotted against the amount of shift (i.e., a position difference expressed in units of micrometers (μm)) by which the position of the reference beam pattern 1 is shifted. As will be understood from FIG. 9, since the reference beam pattern 1 is a random pattern, the autocorrelation function has its maximum value only when the position difference is zero.

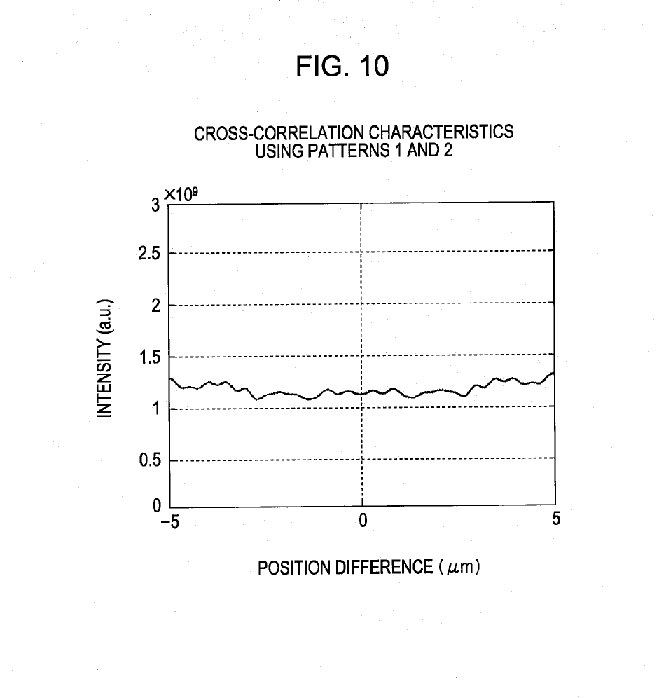

FIG. 10 shows the spatial cross-correlation function between first diffraction fringes and second diffraction fringes, the cross-correlation function being obtained by numerical analysis. The first diffraction fringes were formed by a reference beam based on the reference beam pattern 1 and a signal beam based on an appropriate signal beam pattern (not shown). The second diffraction fringes were formed by a reference beam based on the reference beam pattern 2 and a signal beam based on the same signal beam pattern as that of the first diffraction fringes. In other words, FIG. 10 shows the value (intensity) of the cross-correlation function, serving as spatial convolution, plotted against a position difference (μm: micrometer) by which the position of the reference beam pattern 1 is shifted. As will be understood from FIG. 10, the reference beam patterns 1 and 2 are uncorrelated with each other and are random patterns, the cross-correlation function value is low relative to a position difference. As for selectivity, although the autocorrelation of the reference beam pattern 1 has a peak at the center, the cross-correlation between the reference beam patterns 1 and 2 has no peak. Therefore, the interference characteristics can be remarkably reduced.

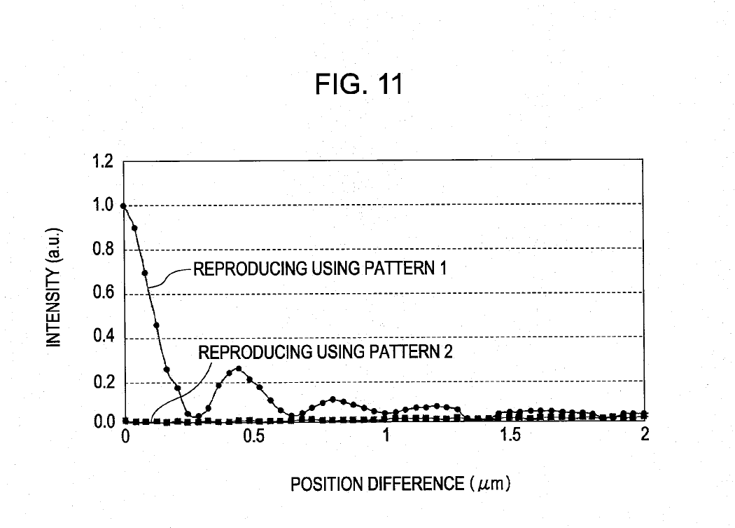

FIG. 11 shows the characteristics obtained when recording and reproducing processes were performed using the reference beam patterns 1 and 2 having the above-described properties. A graph, plotted using filled circles, shows the intensity of a reconstructed beam plotted against a position difference. As for the reconstructed beam, a hologram was formed in a recording layer using the reference beam pattern 1 and the hologram was irradiated with the reference beam pattern 1, thus obtaining the reconstructed beam. A graph, plotted using filled squares, shows the intensity of a reconstructed beam plotted against a position difference, the reconstructed beam being obtained by irradiating the formed hologram with the reference beam pattern 2. Upon reproducing using the reference beam pattern 1, naturally, a good reproduced image and the reconstructed beam having a sufficient intensity were obtained. As will be understood from the graph, in the reproducing operation using the reference beam pattern 1, when a position is shifted by approximately 1 μm, a small amount of light (i.e., crosstalk) was generated. On the other hand, in the reproducing operation using the reference beam pattern 2, a reconstructed beam having a sufficient intensity was not generated in any position. In particular, when the reproducing operation was performed in a recording position, an image was not reproduced. These results show that the use of uncorrelated reference beam patterns can suppress crosstalk as compared with recording and reproducing with a single pattern. Advantageously, the distance between adjacent shift positions on shift multiplexing recording can be reduced.

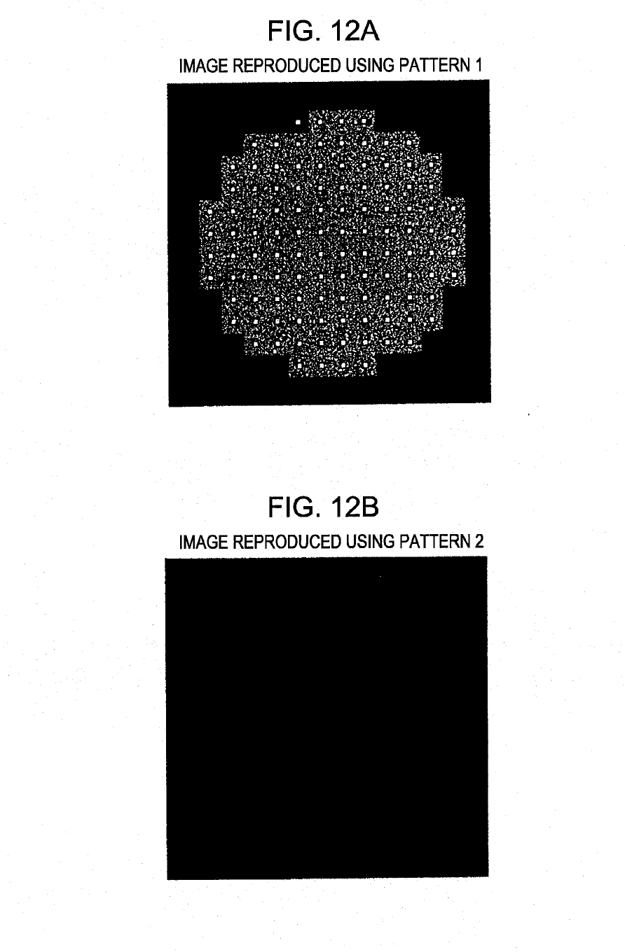

FIG. 12A shows an image reproduced in the image sensor 25 when a hologram was formed using the reference beam pattern 1 and the hologram was irradiated with the reference beam pattern 1. FIG. 12B shows an image reproduced in the image sensor 25 when the above hologram was irradiated with the reference beam pattern 2.

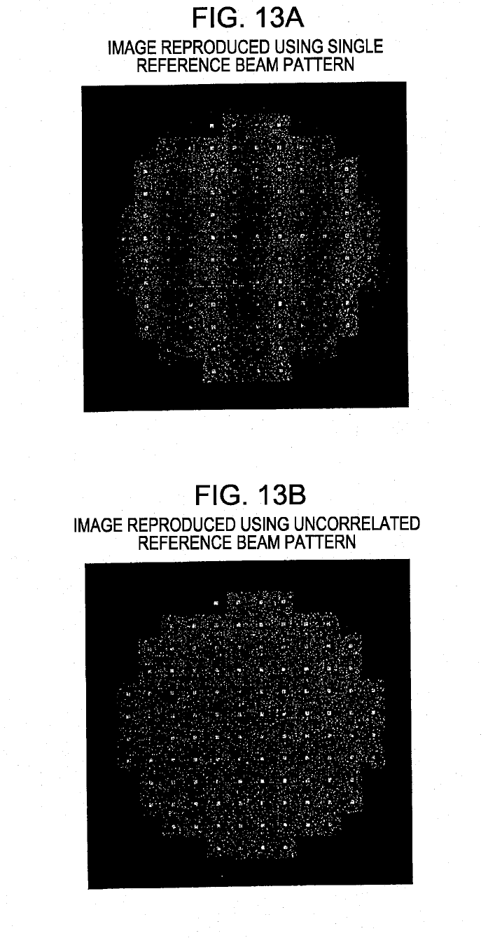

FIG. 13A shows the reproducing characteristics of an image formed in the image sensor 25 on a shift multiplexing recording process performed such that a first hologram was formed using the reference beam pattern 1, a beam spot relative to a holographic recording medium was shifted by 2 μm, and a second hologram was recorded using the reference beam pattern 1. As described above, the second hologram is deviated from the first hologram by 2 μm on the surface of a recording layer. The two holograms overlap each other in an area of the recording layer. FIG. 13B shows the reproducing characteristics of an image formed in the image sensor 25 on another shift multiplexing recording process performed such that a first hologram was recorded using the reference beam pattern 1, a beam spot relative to a holographic recording medium was shifted by 2 μm, and a second hologram was recorded using the reference beam pattern 2. As described above, the second hologram is deviated from the first hologram by 2 μm on the surface of the recording layer. The two holograms overlap each other in an area of the recording layer. Referring to FIG. 13A, interference fringes are included in the image (reproduced image) captured by the image sensor 25 when the first hologram was irradiated with a reference beam based on the reference beam pattern 1. In this case, the SNR (signal-to-noise ratio) was 1.7. Referring to FIG. 13B, interference fringes are not included in the image (reproduced image) captured by the image sensor 25 when the holograms were formed using the two reference beam patterns 1 and 2 by shift multiplexing recording and the first hologram was irradiated with a reference beam based on the reference beam pattern 1. In this case, the SNR was 2.2. Consequently, it is clear that using the reference beam patterns 1 and 2 can improve the multiplexing recording characteristics in the use of the shift multiplexing recording method in which the distance between adjacent shift positions is reduced.

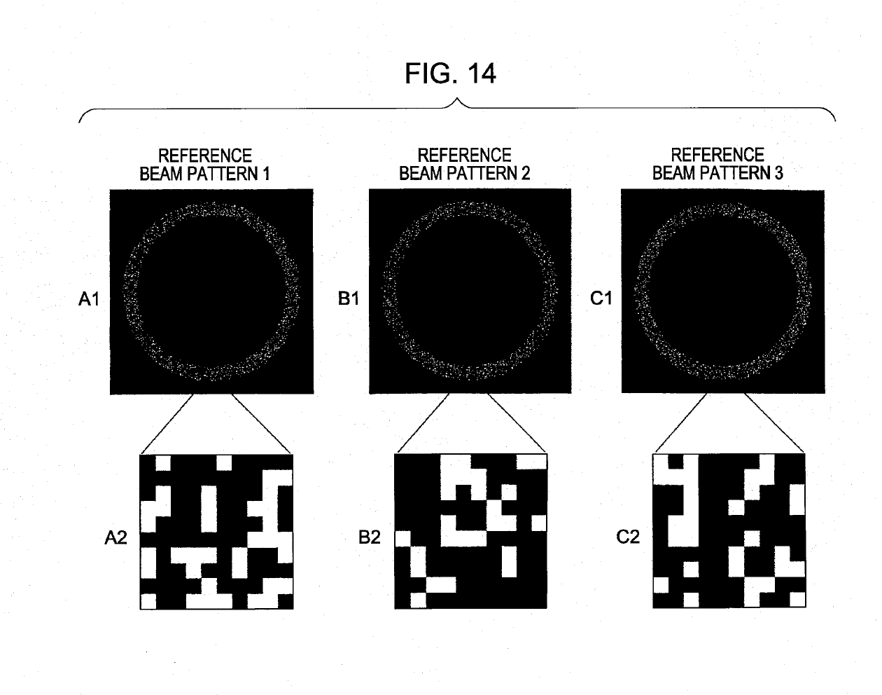

FIG. 14 shows examples using three reference beam patterns. In the use of three or more reference beam patterns, in some cases, it may be difficult to uncorrelate the reference beam pattern with one another. When white pixels are combined with black pixels so that the degree of correlation between the reference beam patterns 1 and 2, that between the reference beam patterns 1 and 3, and that between the reference beam patterns 2 and 3 are as low as possible, a plurality of holograms can be formed such that the holograms overlap one another in an area in a recording layer and good quality images can be reproduced from the holograms. In FIG. 14, part A1 shows an example of the reference beam pattern 1. Part A2 is an enlarged view of part of the reference beam pattern 1. Part B1 shows an example of the reference beam pattern 2. Part B2 is an enlarged view of part of the reference beam pattern 2. Part C1 shows an example of the reference beam pattern 3. Part C2 is an enlarged view of part of the reference beam pattern 3. Since the number of reference beam patterns is large, more holograms can be multiplexed. In the above-described embodiments, the reference beam patterns are random patterns. Other patterns, such as a radial pattern, may be used. In the use of radial reference beam patterns, three or more reference beam patterns can be easily uncorrelated with one another. In the above-described embodiments, two or three patterns are used. The number of patterns is not limited to those examples. Four or more patterns may be used. As for reference beam patterns, the reference beam patterns completely uncorrelated with each other as described above or those having low correlation therebetween may be used. Those conditions may be appropriately selected and used in accordance with requirements on a holographic recording and reproducing system, such as the characteristics of mutual interference between holograms and reproducing power.

It should be appreciated that although the coaxial method in which a signal beam and a reference beam are coaxially arranged has been described, a two-beam method in which a signal beam and a reference beam are incident on a holographic recording medium through different optical components may be used on the basis of the same technical principle. As for a type of spatial light modulator, any of a transmissive type and a reflective type may be used.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A holographic recording and reproducing apparatus for making a signal beam, which is emitted from a light source and is modulated based on recording data for each page, to interfere with a reference beam emitted from the light source to form a hologram in a recording layer of a holographic recording medium and for reproducing the recording data for each page on the basis of a diffracted beam obtained by irradiation of the holographic recording medium with the reference beam, the apparatus comprising:
a signal-beam spatial light modulating unit that displays a signal beam pattern for generating the signal beam;
a reference-beam spatial light modulating unit that displays a reference beam pattern for generating the reference beam; and
a controller that controls the mode of the signal beam pattern displayed in the signal-beam spatial light modulating unit and that of the reference beam pattern displayed in the reference-beam spatial light modulating unit, wherein
the controller controls the modes of at least two signal beam patterns and the modes of at least two reference beam patterns,
the controller allows for recording of at least two recording data units such that a first reference beam generated using a predetermined first reference beam pattern is made to interfere with a first signal beam generated using a first signal beam pattern based on first recording data to record the first recording data in the form of a first hologram in a predetermined area of the holographic recording medium and a second reference beam generated using a predetermined second reference beam pattern is made to interfere with a second signal beam generated using a second signal beam pattern based on second recording data to record the second recording data in the form of a second hologram such that the second hologram is superimposed on the first hologram, and
the controller allows for reproducing at least the two recording data units in such a manner that the first recording data is reproduced on the basis of a diffracted beam obtained by irradiation of the first hologram with the first reference beam and the second recording data is reproduced on the basis of a diffracted beam obtained by irradiation of the second hologram with the second reference beam.

2. The apparatus according to claim 1, wherein the signal-beam spatial light modulating unit and the reference-beam spatial light modulating unit are flush with each other.

3. The apparatus according to claim 1, wherein the controller controls the modes of the at least two reference beam patterns so that when a pixel in one reference beam pattern transmits or reflects a light beam emitted from the light source, the same pixel in the other reference beam pattern does not transmit or reflect the light beam.

4. The apparatus according to claim 1, wherein the controller controls the modes of the at least two reference beam patterns and the modes of the corresponding signal beam patterns so that the degree of spatial cross-correlation between interference fringe patterns caused by the respective reference beam patterns and the corresponding signal beam patterns is low.

5. The apparatus according to claim 4, wherein the controller performs the control operation so that each reference beam pattern has a random pattern.

6. The apparatus according to claim 4, wherein the controller performs the control operation so that at least the first and second holograms are arranged in the same area.

7. The apparatus according to claim 4, wherein the controller performs the control operation so that at least the first and second holograms are arranged so as to share part of one area in the recording layer.

8. The apparatus according to claim 4, wherein the controller performs the control operation so that at least the first and second holograms and a third hologram are arranged so as to share part of one area in the recording layer.

9. The apparatus according to claim 4, wherein the controller performs the control operation so that at least the first and second hologram, a third hologram, and a fourth hologram are arranged so as to share part of one area in the recording layer.

10. A method for holographic recording and reproducing such that a hologram is recorded in a recording layer of a holographic recording medium by allowing a signal beam, which is emitted from a light source and is modulated based on recording data for each page, to interfere with a reference beam emitted from the same light source as that emitting the signal beam and the recording data for each page is reproduced on the basis of a diffracted beam obtained by irradiation of the holographic recording medium with the reference beam, the method comprising:
causing a first reference beam to interfere with a first signal beam based on first recording data to record the first recording data in the form of a first hologram in a predetermined area in the holographic recording medium;
causing a second reference beam to interfere with a second signal beam based on second recording data to record the second recording data in the form of a second hologram such that the second hologram is superimposed on the first hologram;
reproducing the first recording data on the basis of a diffracted beam obtained by irradiation of the first hologram with the first reference beam; and
reproducing the second recording data on the basis of a diffracted beam obtained by irradiation of the second hologram with the second reference beam.
